(19) United States
(12) Patent Application Publication
(10) Pub. No.: US 2004/0218794 A1
(43) Pub. Date: Nov. 4, 2004

(54) Method for processing perfusion images

(76) Inventors: Yi-Hsuan Kao, Taipei City (TW); Yu-Te Wu, Taipei City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/428,264

(22) Filed: May 1, 2003

(51) Int. Cl. G06K 9/00

(52) U.S. Cl. 382/128

(57) ABSTRACT

A method is provided for processing perfusion images of an anatomy of a subject, which were acquired at different times using dynamic susceptibility contrast magnetic resonance imaging after injecting the subject with a contrast agent. The method includes: (a) applying blind source separation to separate the perfusion images into a set of blind source separated images; (b) setting thresholds for the blind source separated images to generate a set of mask images; (c) using the mask images as an initial guess and applying a segmentation technique to generate segmented images; and (d) measuring signal-time curves on the perfusion images using the segmented images. A computer program product including a computer-readable storage medium that contains a computer program for executing the steps of the image processing method is also disclosed.

### BACKGROUND OF THE INVENTION

1. Field of the Invention

This invention relates to a method for processing perfusion images in which voxels are classified using tissue types to achieve good segmentation effects.

2. Description of the Related Art

Dynamic susceptibility contrast magnetic resonance imaging is a widely used imaging tool for in vivo study of cerebral blood perfusion. In this technique, a bolus injection of a contrast agent is administered intravenously. As particles of the contrast agent pass through the brain, magnetic characteristics of tissues change, which in turn results in uneven magnetic fields and corresponding signal changes that reflect blood supply patterns to different tissues. Fast imaging techniques, such as echo planar imaging having a temporal resolution of about one second, can be used to record the signal-change process. Thereafter, according to the indicator dilution theorem and the concentration-time curves of the contrast agent for different tissues, many hemodynamic parameters can be calculated, such as relative cerebral blood volume (rCBV), relative cerebral blood flow (rCBF), and relative mean transit time (rMTT) (see Rosen et al., “Perfusion Imaging with NMR Contrast Agents,” Magnetic Resonance in Medicine 14, 249-265, 1990). Usually, the concentration-time curves for the carotid or vertebral arteries at a remote slice location are used as an arterial input function for the deconvolution calculation of rCBF. These cerebral hemodynamic parameters facilitate diagnosis and staging of brain diseases, such as infarct, occlusive cerebral-vascular disease, stroke, migraine aura, tumor, radiation necrosis, etc.

Because it is difficult to visually incorporate all the information available on blood perfusion images and parametric images, segmentation of blood perfusion images is valuable in distinguishing tissues with different blood supply patterns and in modeling an arterial input function for the deconvolution calculation of rCBF. In Rogowska et al., “A Comparative Analysis of Similarity Mapping and Eigenimaging as Applied to Dynamic MR Imaging of a Low Grade Astrocytoma,” Acta Radiologica 1994, 35(4):371-377, there is disclosed a similarity mapping technique to segment astrocytoma and cysts on cerebral dynamic blood perfusion images. Correlation coefficients for all voxels were calculated using a measured signal-time curve of a region of interest (ROI) as a reference function. In Wiart et al., “Perfusion-based Segmentation of the Human Brain Using Similarity Mapping,” Magnetic Resonance in Medicine, 45(2):261-268, 2001, a modified technique was employed for segmenting gray and white matter on six normal subjects. Particularly, measured arterial input functions and an autoregressive moving average technique were employed to reduce random noise of reference functions, which were measured at different tissue areas. However, the foregoing two techniques require manual selection of ROIs and are limited to only one similarity map per ROI. Because there are many different blood supply patterns that require many user-defined ROIs, application of the foregoing two techniques is cumbersome for the segmentation of cerebral blood perfusion images.

In Martel et al., “Extracting parametric images from dynamic contrast-enhanced MRI studies of the brain using factor analysis,” Medical Image Analysis 2001, 5:29-39, there is disclosed a factor analysis technique, which combined principle component analysis with statistical constraints, to extract factor images and corresponding signal-time curves from perfusion images of 107 studies. The results show that arterial and venous structures dominate first and second factor images. However, the appearance of other output factor images varied considerably among cases, and tissue types were not consistently identified.

In Karhunen et al., “A Class of Neural Networks for Independent Component Analysis,” IEEE Transactions on Neural Networks, Vol. 8, No. 3, May 1997, among others, an independent component analysis (ICA) technique was proposed to separate observed signals into statistically independent source signals. The process as such is also called “blind source separation.” Presently, the ICA technique has been successfully applied to functional MRI data to identify spatially independent cortical activation areas (see McKeown et al., “Analysis of fMRI Data by Blind Separation Into Independent Spatial Components,” Human Brain Mapping 6:160-188, 1998), and to blood perfusion images to remove arterial signals before calculating hemodynamic parameters (see Carroll et al., “Confounding Effect of Large Vessels on MR Perfusion Images Analyzed withIndependentComponentAnalysis,” AJNR AM J Neuroradiol 23:1007-1012, June/July 2002).

### SUMMARY OF THE INVENTION

The main object of the present invention is to provide a method for processing perfusion images which is based on blind source separation and which permits objective and systematic segmentation for tissue characterization so as to improve analysis and interpretation of perfusion images.

Another object of the present invention is to provide a method for processing perfusion images in which an appropriate arterial input function on the same slice location may be defined for calculation of hemodynamic parameters.

According to one aspect of the invention, there is provided a method for processing perfusion images of an anatomy of a subject which were acquired at different times using dynamic susceptibility contrast magnetic resonance imaging after injecting the subject with a contrast agent. The method comprises the steps of:

(a) applying blind source separation to separate the perfusion images into a set of blind source separated images;

(b) setting thresholds for the blind source separated images to generate a set of mask images; and

(c) measuring signal-time curves on the perfusion images from the mask images.

According to another aspect of the invention, there is provided a method for processing perfusion images of an anatomy of a subject which were acquired at different times using dynamic susceptibility contrast magnetic resonance imaging after injecting the subject with a contrast agent. The method comprises the steps of:

(a) applying blind source separation to separate the perfusion images into a set of blind source separated images;

(b) setting thresholds for the blind source separated images to generate a set of mask images;

(c) using the mask images as an initial guess to assign voxels therein among different tissues of the anatomy of the subject;

(d) applying a segmentation process to adjust assignments of the voxels among the different tissues and to generate segmented images; and

(e) measuring signal-time curves of the different tissues on the perfusion images using the segmented images.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a flowchart to illustrate consecutive steps of the preferred embodiment of a method for processing perfusion images according to the present invention;

FIG. 2(a) illustrates a first original perfusion image acquired from a volunteer to show baseline signals according to the method of the preferred embodiment;

FIG. 2(b) illustrates a twenty-ninth original perfusion image acquired from the volunteer to show maximum signal drops according to the method of the preferred embodiment;

FIG. 2(c) is a difference image of FIGS. 2(a) and (2b);

FIG. 2(d) illustrates an anatomical proton-density-weighted-image for verification purposes;

FIG. 3(a) illustrates plots of normalized signal-time curves obtained from the application of ICA on original perfusion images, where the number (N) of output independent-component images (or blind source separated images) is equal to 5, to reveal sequential passage of contrast agent;

FIG. 3(b) illustrates an exemplary independent-component image corresponding to coroid plexus (CP) and acquired according to the method of the preferred embodiment;

FIG. 3(c) illustrates an exemplary independent-component image corresponding to artery and acquired according to the method of the preferred embodiment;

FIG. 3(d) illustrates an exemplary independent-component image corresponding to vein and sinus (VS) and acquired according to the method of the preferred embodiment;

FIG. 3(e) illustrates an exemplary independent-component image corresponding to gray matter and acquired according to the method of the preferred embodiment;

FIG. 3(f) illustrates an exemplary independent-component image corresponding to white matter and acquired according to the method of the preferred embodiment;

FIGS. 4(a) to 4(e) respectively illustrate five mask images for coroid plexus, artery, vein and sinus, gray matter, and white matter generated by applying different thresholds to the independent-component images of FIGS. 3(b) to 3(f) in accordance with the method of the preferred embodiment;

FIG. 5(a) illustrates an exemplary final segmentation result, in the form of a composite image, acquired through the method of the preferred embodiment with the use of the Bayesian estimation;

FIGS. 5(b) and 5(c) respectively illustrate measured and normalized signal-time curves for segmented tissue types and obtained in accordance with the method of the preferred embodiment;

FIG. 5(d) illustrates concentration-time curves for the segmented tissue types and calculated in accordance with the method of the preferred embodiment;

FIG. 5(e) illustrates rescaled concentration-time curves corresponding to those shown in FIG. 5(d), in which the concentrations were rescaled to the maximum value of each tissue; and

FIG. 6(a), 6(b), and 6(c) respectively illustrate parametric rCBV, rCBF and rMTT images for the perfusion images and calculated on a voxel-by-voxel basis in accordance with the method of the preferred embodiment.

### DETAILED DESCRIPTION OF THE PREFERRED EMBODIMENT

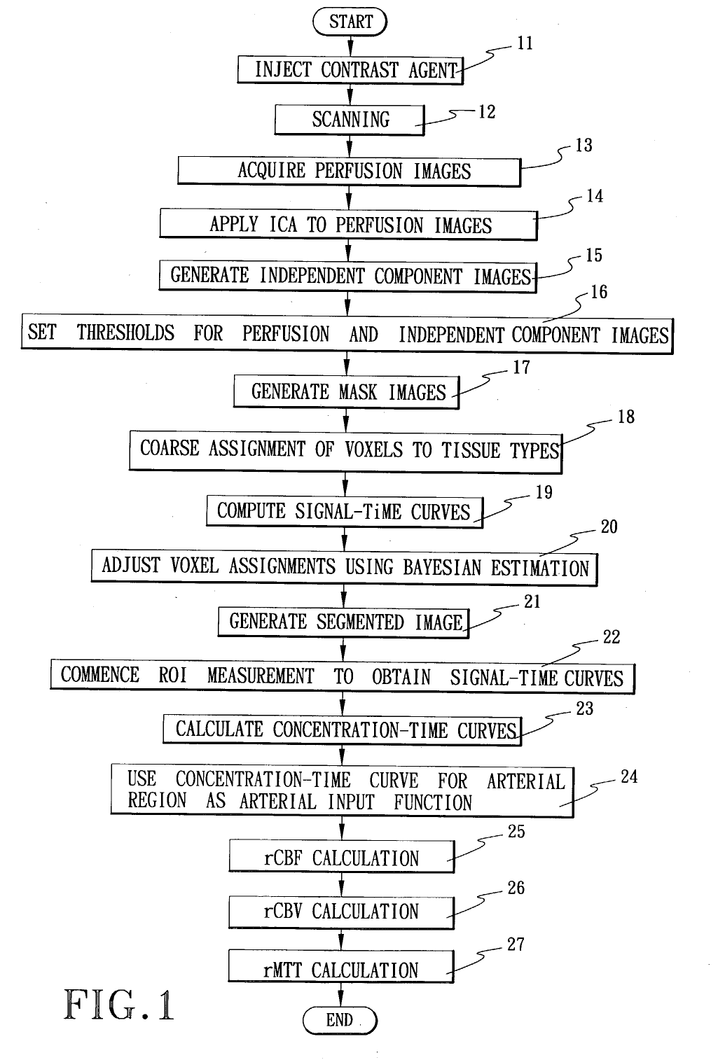

FIG. 1 is a flowchart to illustrate consecutive steps of the preferred embodiment of a method for processing perfusion images according to the present invention. The method of the preferred embodiment was performed on a volunteer for generating perfusion images and for perfusion image processing.

In step 11, 20 ml of GD-DTPA-BMA (Omniscan®, 0.5 mmol/ml, Nycomed Imaging, Oslo, Norway), which serves as a contrast agent, followed by 20 ml of normal saline, was administered through an antecubital vein of the volunteer at a flow rate of 3 ml/sec using a power injector (Spectris®, Medrad inc., Indianola, Pa.). Thereafter, in step 12, brain perfusion images of the volunteer were acquired using a 1.5-Tesla clinical scanner (Sigma CVi®, GE Medical Systems, Milwaukee, Wis.). The scan parameters were: TE/TR=60/1000 ms; flip angle=90 degrees; field of view=24×24 cm; image matrix=128×128; slice thickness=5 cm; gap=5 mm; three slices; one averaging; and 100 images per slice location. In step 13, seventy perfusion images with a temporal resolution of one second were acquired for each slice location for subsequent perfusion image processing.

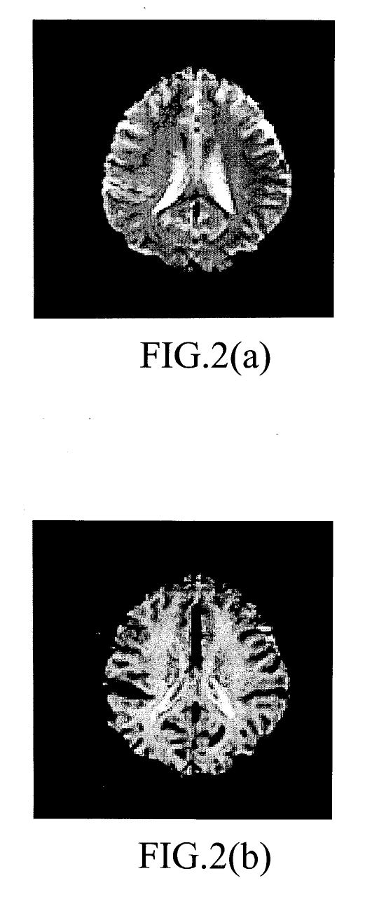

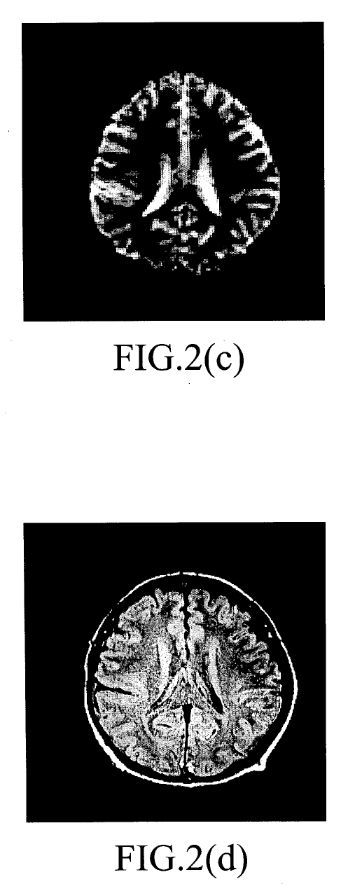

FIGS. 2(a) and 2(b) illustrate the first and twenty-ninth perfusion images at an upper slice location for the volunteer, showing the baseline image and the image with maximum signal drops, respectively. FIG. 2(c) is a difference image of FIGS. 2(a) and (2b) to illustrate detected susceptibility contrast attributed to passage of the contrast agent. FIG. 2(d) is an anatomical proton-density-weighted-image for verification purposes. It is noted that choroids plexus and cerebral spinal fluid are well observed in FIGS. 2(b) and 2(d).

Tissues with different blood supply patterns are assumed to have a spatially independent distribution on the perfusion images so that they could be distinguished by blind source separation. Accordingly, in step 14, FastICA is employed in the preferred embodiment to process the perfusion images. Details of the FastICA technique can be found in, for example, Hyvarinen, “Fast and Robust Fixed-Point Algorithms for Independent Component Analysis,” IEEE Transactions on Neural Networks, Vol. 10, No. 3, May 1999.

In the preferred embodiment, based on visual examination of computed blind source separated images (hereinafter referred to as independent-component images) for different numbers (N) of output independent-component images, together with knowledge on anatomy, N=5 was concluded. In step 15, it was found that the generated independent-component images actually provided only a coarse segmentation of the perfusion images. Furthermore, because the corresponding signal-time curves were processed during the optimization procedure of the FastICA, they cannot represent the actual signal-time curves and are unsuited for use in the calculations of hemodynamic parameters.

To improve segmentation results, thresholding and Bayesian estimation were applied on the perfusion and independent-component images according to the preferred embodiment of the method of this invention. In some functional MRI studies, such as McKeown et al., “Analysis of fMRI Data by Blind Separation Into Independent Spatial Components,” Human Brain Mapping 6:160-188, 1998, task-related areas were identified by suitable thresholding on independent-component images. In step 16, similar to these functional MRI studies, different thresholds were set for the five independent-component images corresponding to CP, artery, VS, gray matter, and white matter. Accordingly, corresponding mask images are generated in step 17. Each mask image contains a higher percentage of voxels belonging to the corresponding tissue type. In the preferred embodiment, a threshold was applied on the twenty-ninth perfusion image (see FIG. 2(b)) to generate a mask for cerebral spinal fluid (CSF).

Thereafter, in steps 18 to 20, the mask images thus generated were used as an initial guess in the Bayesian estimation so that each voxel may be assigned to a single tissue type. The probability density function for each tissue type was determined according to voxel numbers in the six mask images. Sample means and sample variance matrices for the signal-time curves were computed for voxels in the mask images as an estimate of the mean signal-time curve for each tissue type and the covariance matrix of mean signal-time curves for voxels belonging to the same tissue type. In the Bayesian estimation, each voxel was assigned to the tissue type with the largest posterior probability. Accordingly, instep 21, a composite segmented image, preferably color-coded, was generated to illustrate the assignments. Next, in step 22, the assignments were used as new ROIs to compute the averaged signals across time, which are considered as the true signal-time curves.

In step 23, for the hemodynamic-parameter calculations, a linear relationship described in the following Equation (I) was assumed between cₜ(t), which is the contrast-agent concentration-time curve in a voxel of a tissue, and ΔR₂ (t), which is the change of relaxation rate:

cₜ(t)∝ΔR₂(t)∝−(1/TE)ln[S(t)/S₀] (I)

where TE is the echo time, S(t) is the signal at time t, and S₀ is the baseline signal for a voxel. For additional information in connection with the aforesaid linear relationship, one can refer to Rosen et al., “Perfusion Imaging with NMR Contrast Agents,” Magnetic Resonance in Medicine 14, 249-265, 1990; Rempp et al., “Quantification of Regional Cerebral Blood Flow and Volume with Dynamic Susceptibility Contrast-enhanced MR Imaging,” Radiology 1994, 193:637-641; and Ostergaard et al., “High Resolution Measurement of Cerebral Blood Flow Using Intravascular Tracer Bolus Passages. Part II: Experimental Comparison and Preliminary Results,” Magnetic Resonance in Medicine 1996, 36:726-736, among others.

In steps 24 and 25, the concentration-time curve for the arterial region on the same slice was used as the arterial input function in the subsequent rCBF calculation. In step 26, based on residue detection of the indicator dilution theorem, during the first passage of a contrast agent, the rCBV for a voxel is equal to the integration of a concentration-time curve cₜ(t) of a tissue voxel divided by the integration of a concentration-time curve cₐ(t) of the arterial input function for the voxel, as indicated in the following Equation (II):

rCBV∝∫cₜ(t)dt/∫cₐ(t)dt (II)

The concentration-time curve of a tissue voxel can also be expressed as follows:

cₜ(t)=rCBF·cₐ(t)\mathring{×}R(t) (III)

where \mathring{×} denotes convolution and R(t) is the voxel residue function. Once cₐ(t) is known, the rCBF·R(t) curve for a voxel can be calculated using the singular value deconvolution technique. Because R (t=0)=1 as the indicator dilution theory assumes, the initial value of the deconvoluted curve is equal to the rCBF. However, it was demonstrated in the aforesaid reference, i.e., Ostergaard et al., “High Resolution Measurement of Cerebral Blood Flow Using Intravascular Tracer Bolus Passages. Part II: Experimental Comparison and Preliminary Results,” that there are temporal delays observed on the rCBF·R(t) curve at different tissues. Therefore, instead of the initial value, the maximum value of the rCBF·R(t) curve is used as the rCBF value. In step 27, using the central volume principle, the rMTT for contrast-agent particles to pass through a voxel can be calculated according to the following Equation (IV):

rMTT=rCBV/rCBF (IV)

Therefore, using Equations I-IV, the rCBV, rCBF and rMTT values can be calculated for the regions of the different tissues. The rCBV was calculated as the area under the concentration-time curve for data from the twentieth to the forty-second second. In the deconvolution calculation of rCBF, all seventy data were used, and a cut-off value was set at 20% of the maximum eigenvalue in the singular value decomposition calculation to reduce random noise. Details in this regard can be found in the aforesaid reference, i.e., Ostergaard et al., “High Resolution Measurement of Cerebral Blood Flow Using Intravascular Tracer Bolus Passages. Part II: Experimental Comparison and Preliminary Results.” Parametric images for rCBV, rCBF and rMTT were also calculated on a voxel-by-voxel basis.

Upon conducting the steps of the method of the preferred embodiment in accordance with the foregoing description, the results will now be described with reference to the accompanying drawings.

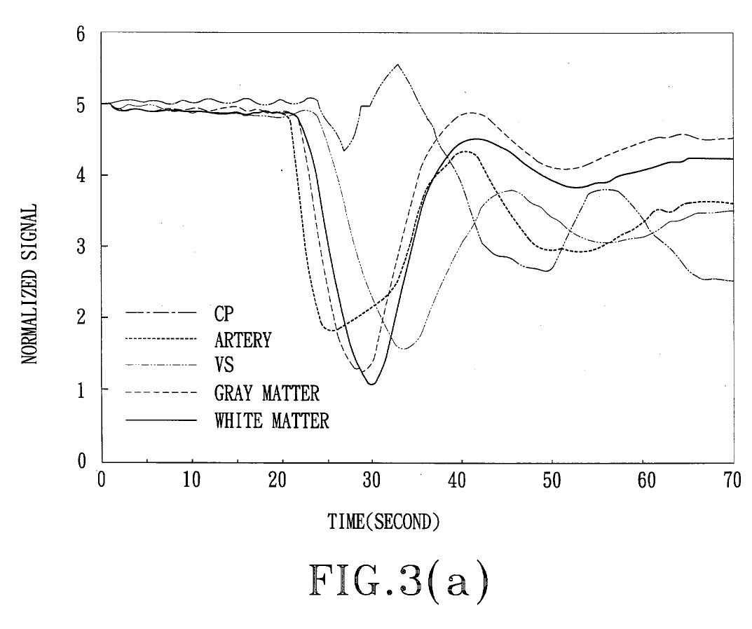

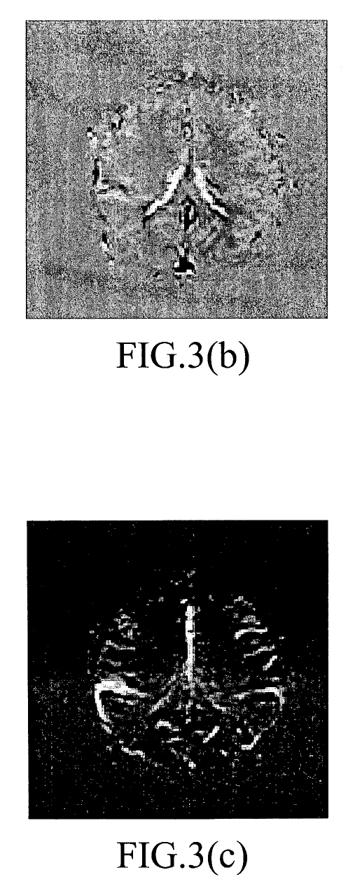

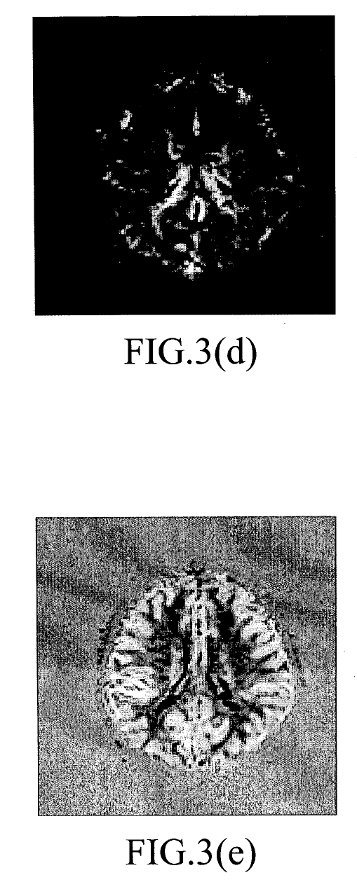

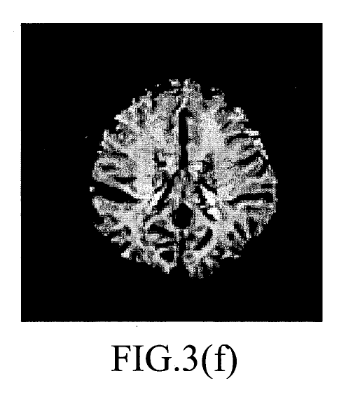

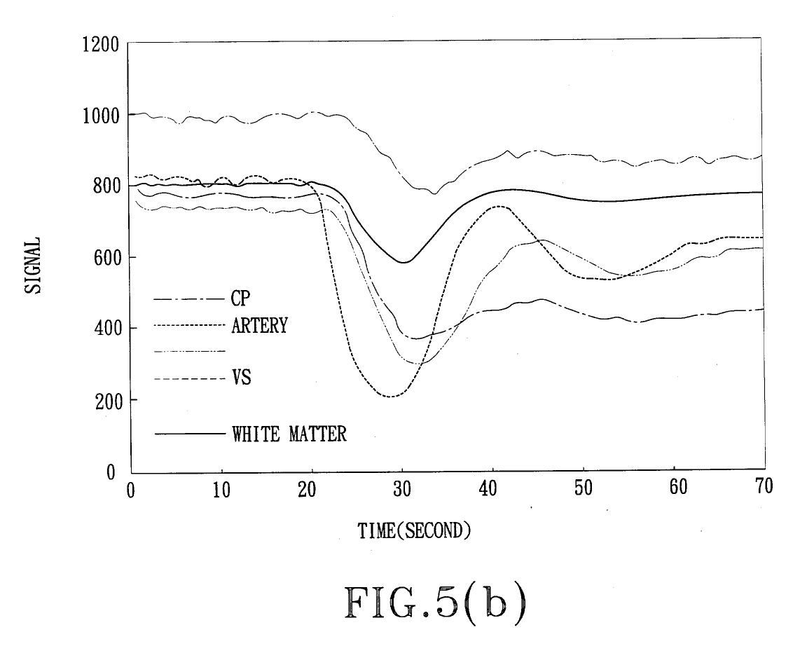

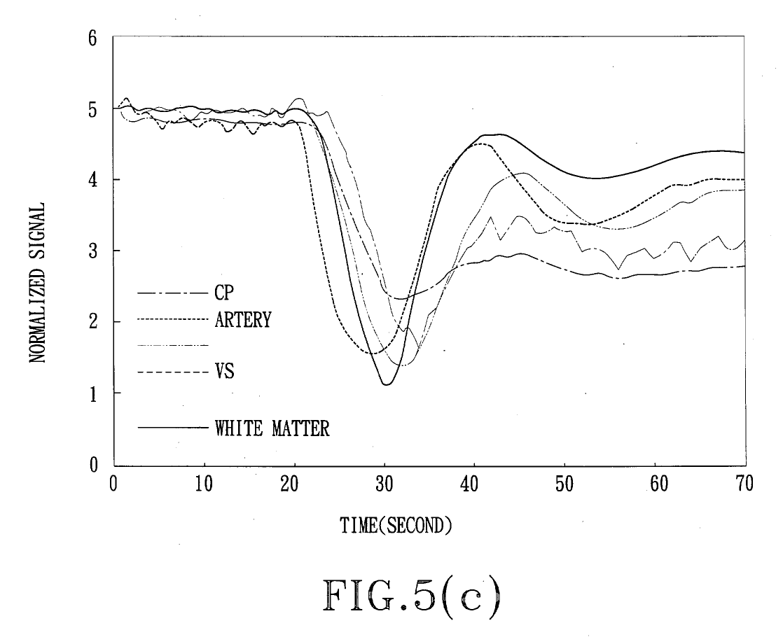

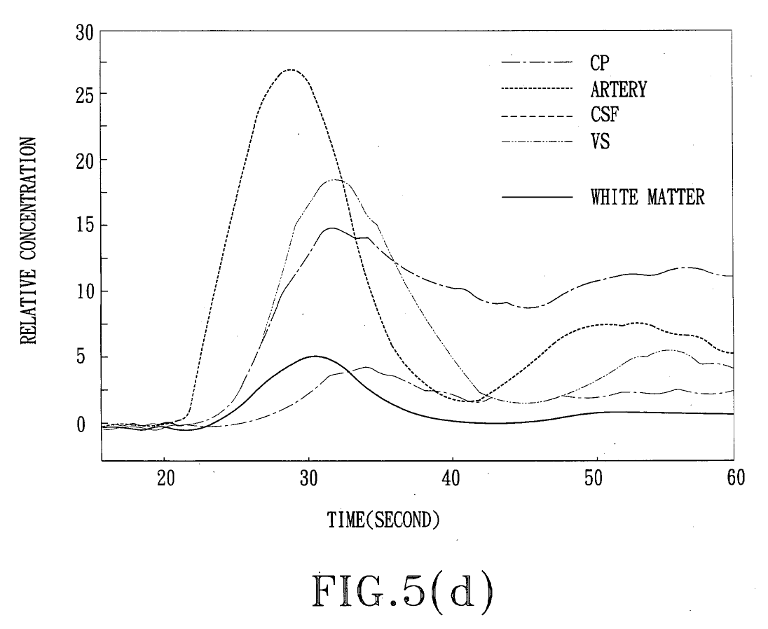

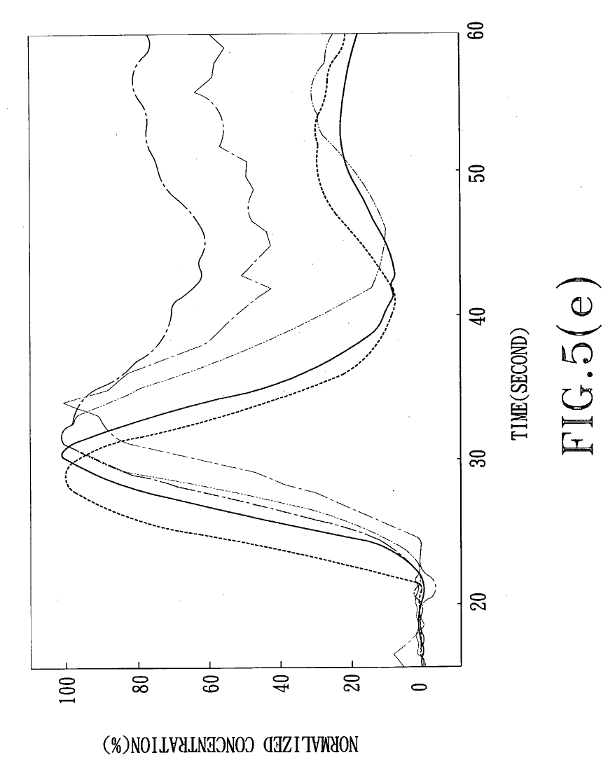

FIG. 3(a) is a plot to illustrate the application of FastICA on perfusion images with the number (N) of output independent-component images equal to 5. Particularly, FIG. 3(a) illustrates plots of measured signal-time curves that were all normalized to a constant (unity) variance and that have initial values shifted to 5.0 (i.e., baseline signals were moved to a same level) for comparison with FIG. 5(c). Each independent-component image consisted of two or three tissue types. The major tissue types of the five independent-component images were CP (see FIG. 3(b)), artery (see FIG. 3(c)), VS (see FIG. 3(d)), gray matter (see FIG. 3(e)), and white matter (see FIG. 3(f)).

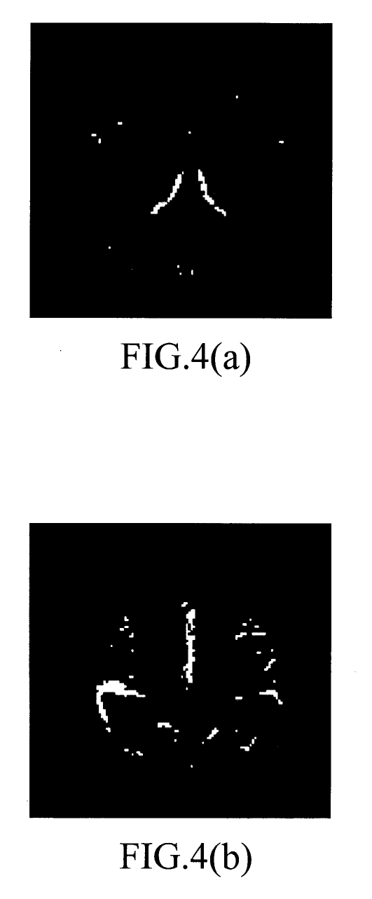

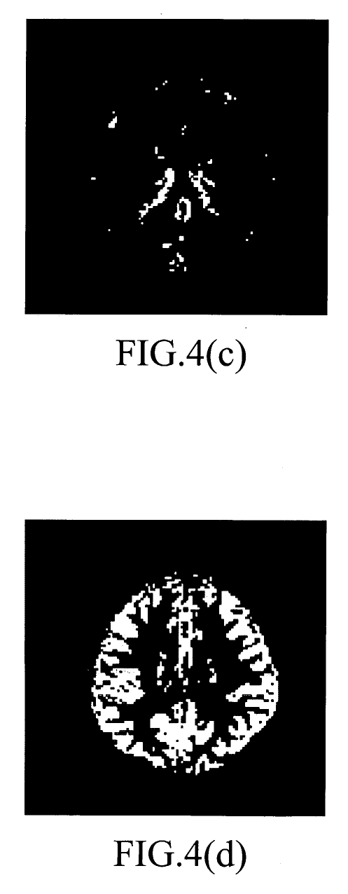

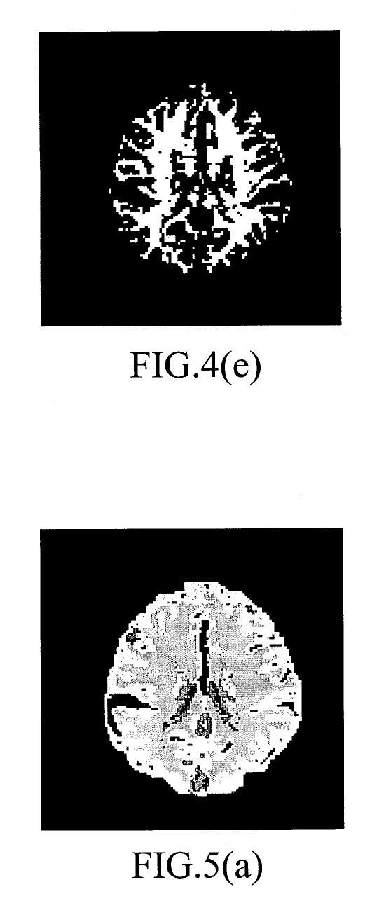

FIGS. 4(a) to 4(e) illustrate five mask images produced by applying different thresholds to the independent-component images of FIGS. 3(b) to 3(f). According to the anatomical proton-density-weighted image shown in FIG. 2(d), it is clear that most of the CP and artery were individually separated as shown in FIGS. 4(a) and 4(b), respectively. In FIG. 4(c), most of the bright voxels were VS, while the remaining voxels belong to the CP. In FIG. 4(d), most of the bright voxels were gray matter, and some voxels were artery. In FIG. 4(e), the major tissue type was white matter that was mixed with CSF. To overcome the situation that some voxels appeared bright several times in the initial assignments, mask images were generated in the method of the preferred embodiment in the following order: artery, CP, CSF, VS, gray matter, and white matter. Whenever a voxel was assigned to a tissue type, it will be excluded from the remaining assignment process. Six final mask images were created and were fine tuned using the Bayesian estimation. In addition, the initial ROI of FIG. 4(b) can be used to measure the arterial signal-time curve, from which the arterial input function can be calculated.

FIG. 5(a) illustrates the final segmentation result, using the Bayesian estimation, in the form of a composite image, preferably color-coded. For hemodynamic analysis, different colored areas were used as ROIs to compute the true signal-time curves on the perfusion images. The segmentation result of the composite image of FIG. 5(a) in which voxels of different perfusion dynamics can be grouped together, is consistent with the anatomical proton-density-weighted image shown in FIG. 2(d). FIGS. 5(b) and 5(c) respectively illustrate measured and normalized signal-time curves. As shown in FIG. 5(c), the normalized signal-time curves for CP and artery are greatly improved as compared to those found in FIG. 3(a). FIG. 5(d) illustrates plots of concentration-time curves for the segmented tissues as calculated through the use of Equation (I). The concentration-time curve of the arterial region was modeled as an arterial input function for subsequent rCBF calculations.

To illustrate the sequential passage of contrast agent, the curves shown in FIG. 5(d) were rescaled to their maximum values, as illustrated in FIG. 5(e). The rescaled curves demonstrate that the bolus of contrast agent arrived at the artery first, followed by gray matter, white matter, and VS. Good re-circulation at these tissue types was observed, indicating that their blood brain barrier were all intact. However, CP and CSF have different curve patterns in view of their different microcirculation.

In the calculation of cerebral hemodynamic parameters, the concentration-time curve of a middle cerebral artery or an internal carotid artery at a remote slice location is selected for the arterial input function in the known art. However, in the method of the present invention, which combines ICA, thresholding and Bayesian estimation techniques, an arterial region and corresponding concentration-time curve can be provided on the same slice, which is an easy and obvious choice for the arterial input function.

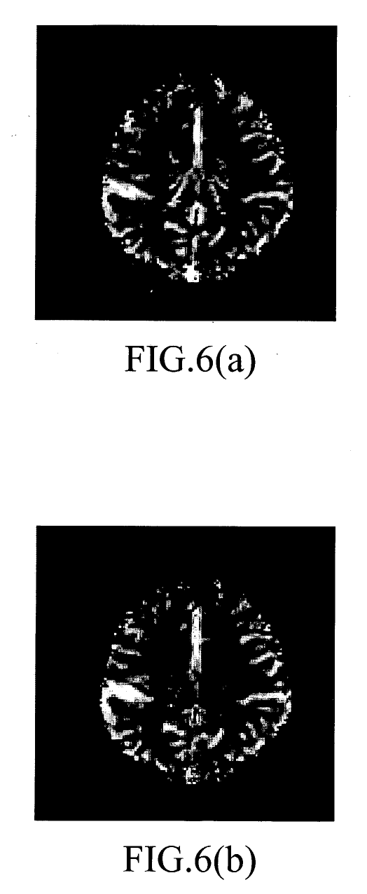

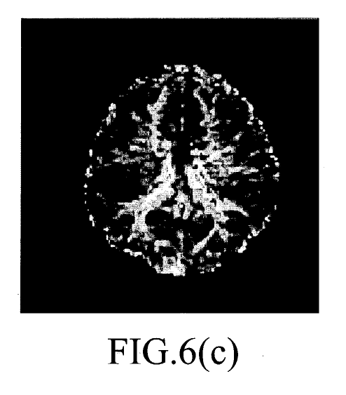

FIGS. 6(a), 6(b), and 6(c) respectively illustrate parametric rCBV, rCBF and rMTT images for the perfusion images. Because the concentration-time curve for the arterial region on the same slice was used for the rCBF calculation, these parametric images display good contrast among tissues.

This invention can be considered as a ROI selection method, in which voxels are classified and then grouped together, according to their signal-time curves and the assumption of spatial independence. In the method of the preferred embodiment, thresholding and Bayesian estimation were further applied on independent-component images to classify voxels by tissue type. After creating mask images as an initial guess of tissue assignment, in addition to Bayesian estimation, other techniques, such as k nearest neighbor or fuzzy C-means taught in Clarke et al., “MRI Segmentation: Methods and Application,” Magnetic Resonance Imaging, Vol. 13, No. 3, 343-368, 1995, or Markov random field taught in Choi et al., “Partial Volume Tissue Classification of Multi Channel Magnetic Resonance Images—A Mixed Model,” IEEE Transactions on Medical Imaging Vol. 10, No. 3, 395-407, September 1991, among others, can also be used to further improve tissue classification. Alternatively, the perfusion images can be processed repeatedly by ICA. At each step, only one independent-component image is selected from the resultant independent-component images to generate a mask image via thresholding. The mask image is used to select voxels whose intensities are averaged to create the signal-time curve of a tissue type. The selected voxels, tagged as an identified tissue type, are removed from the perfusion images in the next step. The same procedure is repeated until all of the voxels are classified.

Before applying ICA, the perfusion images can be pre-processed by filtering to increase the signal-to-noise level, image registration to correct the image motion, morphological operations or other mathematical calculations to remove the voxels corresponding to skull and scalp regions, or a binary mask to select the brain region.

Moreover, it is apparent to those skilled in the art that the various steps of the method of the preferred embodiment can be automatically executed through a computer program product for faster processing. For example, selection of threshold values can be automated according to preset values for different tissue types. Preferably, the computer program product of the present invention includes a computer-readable storage medium, such as a diskette, a hard disk or a magnetic tape, for storing a computer program to enable processing equipment, such as a computer, to execute the various steps of the method of the preferred embodiment.

In conclusion, the method of this invention for processing perfusion images provides a tool for better understanding of human hemodynamics. Some of the advantages of the present invention include: (1) the concurrent and systematic segmentation of tissues with different hemodynamic patterns; (2) the delineation of sequential passages and microcirculation of contrast agent to the segmented tissues; and (3) the effective modeling of an arterial input function on the same slice location for rCBF calculations.

It is noted herein that variations of blind source separation, such as projection pursuit (see Chapter 14 of Hastie et al., “The Elements of Statistical Learning: Data Mining, Inference, and Prediction,” Springer Series in Statistics, Springer-Verlag, 2001) or exploratory data analysis can be applied to replace ICA.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A method for processing perfusion images of an anatomy of a subject which were acquired at different times using dynamic susceptibility contrast magnetic resonance imaging after injecting the subject with a contrast agent, said method comprising the steps of:
(a) applying blind source separation to separate the perfusion images into a set of blind source separated images;
(b) setting thresholds for the blind source separated images to generate a set of mask images; and
(c) measuring signal-time curves on the perfusion images from the mask images.

2. The method as claimed in claim 1, wherein in step (b), different thresholds are set for the blind source separated images according to different tissues of the anatomy of the subject such that each of the mask images contains a higher percentage of voxels belonging to a corresponding tissue type.

3. The method as claimed in claim 1, the anatomy of the subject including an arterial region, further comprising the step of converting the signal-time curve measured from the mask image that corresponds to the arterial region into a concentration-time curve, which serves as an arterial input function.

4. The method as claimed in claim 1, further comprising the steps of normalizing the measured signal-time curves obtained in step (c) to a constant variance, and moving baseline signals of the measured signal-time curves to a same level for comparison.

5. A method for processing perfusion images of an anatomy of a subject which were acquired at different times using dynamic susceptibility contrast magnetic resonance imaging after injecting the subject with a contrast agent, said method comprising the steps of:
(a) applying blind source separation to separate the perfusion images into a set of blind source separated images;
(b) setting thresholds for the blind source separated images to generate a set of mask images;
(c) using the mask images as an initial guess to assign voxels therein among different tissues of the anatomy of the subject;
(d) applying a segmentation process to adjust assignments of the voxels among the different tissues and to generate segmented images; and
(e) measuring signal-time curves of the different tissues on the perfusion images using the segmented images.

6. The method as claimed in claim 5, wherein in step (b), different thresholds are set for the blind source separated images according to the different tissues of the anatomy of the subject such that each of the mask images contains a higher percentage of voxels belonging to a corresponding tissue type.

7. The method as claimed in claim 5, wherein the segmentation process in step (d) includes Bayesian estimation.

8. The method as claimed in claim 5, further comprising the steps of (f) normalizing the measured signal-time curves obtained in step (e) to a constant variance, and (g) moving baseline signals of the measured signal-time curves to a same level for comparison.

9. The method as claimed in claim 5, further comprising the step of (h) converting the signal-time curves measured using the segmented images into corresponding concentration-time curves.

10. The method as claimed in claim 9, the anatomy of the subject including an arterial region, wherein the concentration-time curve converted from the signal-time curve that was measured using the segmented image, which corresponds to the arterial region, serves as an arterial input function.

11. The method as claimed in claim 9, further comprising the step of (i) normalizing the concentration-time curves for the different tissues to corresponding maximum values for comparison purposes.

12. A computer program product comprising a computer-readable storage medium that contains a computer program for enabling automated execution of the steps of the method as claimed in claim 1.

13. A computer program product comprising a computer-readable storage medium that contains a computer program for enabling automated execution of the steps of the method as claimed in claim 5.
